(19) United States
(12) Patent Application Publication
(10) Pub. No.: US 2019/0361149 A1
(43) Pub. Date: Nov. 28, 2019

(54) Real-Time Snow Monitoring System

(71) Applicant: Daniel Robert Fajardo, Papillion, NE (US)

(72) Inventor: Daniel Robert Fajardo, Papillion, NE (US)

(21) Appl. No.: 16/357,472

(22) Filed: Mar. 19, 2019

Related U.S. Application Data
(60) Provisional application No. 62/646,586, filed on Mar. 22, 2018.

(51) Int. Cl. G01W 1/06; B60W 40/06; G01W 1/16; G06K 9/00

(52) U.S. Cl. CPC G01W 1/06; B60W 40/06; B60W 2550/12; G06K 9/0063; G01W 2203/00; G01W 1/16

(57) ABSTRACT

A snow sensor array device and processing system designed for handling snow amount capture the following environmental conditions: temperature, barometric pressure, GPS, and pictures through wireless and wired communication mediums. The snow sensor array packages all the environmental data it collects and transmits to database. A GPS device on a mobile commercial snow service reports its movement to the database. The combined information is used for analyzing real-time snowfall conditions within a geographical space to provide snowfall amounts, dangerous conditions, and safe routes for travel in that space. A content delivery system will then produce human readable maps and text output from the processing system.

### FIELD OF THE INVENTION

The functions of this invention are to find real-time amounts of snow and metrics (temperatures, barometric pressures, GPS, and pictures) in multiple geographic areas, and to provide map-formatted visual displays that will enable humans to understand real-time snow conditions in these areas. This invention will deliver its packaged metrics in intervals, along with mobile commercial snow removal services GPS information and a real-time safety system that relays information via a map-formatted visual display. Humans will then use this information to understand dangerous conditions and to develop the safest routes in the mapped space.

### BACKGROUND OF THE INVENTION

Snowstorms are difficult to predict because of many uncertainties, constantly changing variables and lack of real-time local weather data. Incorrect forecasting of snowstorms significantly affects our daily lives by influencing school or businesses closings and prioritizing plow truck routes. Current sensor systems collect weather related data on highways and estimate snow depths in the mountains. The Weather Sensor System (WSS) distributed system, using the snow sensor array, will monitor local real-time snow conditions at a more granular level. Sensors collecting precipitation and temperature data will be attached to fixed locations and on plow trucks in densities relative to population density. The data is transferred via a communication network enabled device to decentralized servers, hosted under Amazon Web Services, performing different functions within WSS. Physical security and encryption will be utilized throughout WSS to protect sensor data. Data synchronization will be managed using network time protocol (NTP). Real-time data will be overlaid on maps producing easily interpreted, accurate snow maps with much greater detail than are currently available. The summarized local real-time information is shared with local municipalities, national weather service, and companies/individuals through subscriptions or web portal access. Information provided by WSS combined with existing data will allow officials to make better decisions on closings and plow routes, reducing waste and disruption while maintaining public safety.

In the City of Omaha located in the Midwestern USA, there can be many snowstorms during the winter season each year. There are numerous stories about the inaccuracy of snowstorm forecasting in the Omaha area including one on Mar. 9, 2017, 3-4 inches of snow was forecast in the morning, the forecast was reduced to 2-3″ that afternoon and actual snowfall the next day varied from trace amounts to 1″. What happened with the forecast compared to actual?

Also, snowstorms are difficult to predict because of many uncertainties and factors such as lack of model agreement and the unpredictability of swift moving events. Meteorologists attempt to predict storms based on data from satellites, radar, digital forecasting models, local weather stations, and balloons. However, storm factors such as the chaotic nature of the atmosphere and shifts in storm tracking affect forecasting. Because it is difficult to accurately predict snowstorms, there have been quite a few incorrect decisions about declaring closings for schools and businesses just this winter season. For example, the snowstorm of Jan. 15-16, 2017 in Omaha was predicted to be little to no snow. Instead, icy rain and snow caused dangerous conditions creating significant public safety concerns. The forecast mentioned previously from March 9th had the opposite issue, with a closing decision made on higher amounts anticipated than actually accumulated costing school and businesses a fortune because of the unnecessary closure. Furthermore, the city's snow trucks needing to spread sand before a storm, rely on forecasting to determine pre-storm preparations. Preparing for higher accumulations than what actually occurs can cost hundreds of thousands of dollars and even up to two million dollars for a single storm. Preparing for lower accumulations than what actually occurs will bring more risk to school buses and workers driving in bad road conditions because snow makes driving more dangerous due to reducing tire adherence and impairing visibility. Students will also be at risk because they will be outside, exposed to harsh conditions, while waiting for the school bus in severe weather situations.

The Weather Sensor System, using the snow sensor array, can monitor local, real-time snow conditions. The WSS, distributed around a city with sensor density based on the population density and geography, will be sensor arrays attached to buildings, cellphone towers and plow trucks. The sensor arrays, with two-gigabyte solid state memory, will consist of a temperature sensor, a moisture collector/sensor measuring precipitation amounts and rates, a heating unit connected to the body of the sensory array to keep the unit above freezing to allow the moisture sensor to process moisture, a GPS for positioning info, a barometric pressure sensor for barometric info, and a camera sensor for still images. A Logical processing unit will have all the components connected to it for packaging of data. Then, through a controller board communicating with sensors, the data will be transferred via a network enabled communication device. The data from the static location sensors will be transferred to decentralized collection servers. Plow truck sensor data will be sent first to the local plow company's server, and then transferred to its designated decentralized collection server. All sensor data sent to the collection servers will then be transferred to decentralized application servers for analytical processing. Processed data will be sent to content delivery servers for local distribution of information to subscribing services. All these servers, except local plow company servers, will use Amazon Web Services as a cloud solution. An information portal for retrieving data for external processing will be made available for big data processing. In the city, the summarized local real-time information can be shared with local municipalities, National Weather Service, and companies/individuals through data subscriptions or web portal access.

Overall, the sensor array system and multi-tier server architectures are designed to monitor local real-time snow conditions. The system can be used not only for providing real-time data but can also be combined with existing weather services such as satellite, radar, and historical weather data to support, municipalities, forecasters, researchers, and other private customers. Implementing WSS with the snow sensory array, will result in better information that can be included in the decision-making process for determining school, company, and local communities' closures and allow better utilization of plow-truck services.

### SUMMARY OF THE INVENTION

This snow sensor unit will provide a weather sensor system for delivering real-time snowfall and road conditions. It will produce visual maps showing area locations, road conditions, amount of snow in each area, and whether snow has been plowed or not, and pictures of area where sensor is located at.

The sensor unit container will have a moisture collector on top of it that captures snow. The snow will fall into the top casing and remain there until melted by the Device Heating Unit.

The Device Heating Unit within the snow sensor will keep the temperature of the snow above freezing to allow it to drip into the sensor for measurement. This device will have an internal temperature sensor to limit heating only up to 40 degrees Fahrenheit, thus preventing overheating.

The snow sensor unit will contain a snow/moisture sensor to determine the amount of snowfall. The sensor will allow moisture, heated from the Device Heating Unit, to come from the moisture collector through the snow/moisture sensor, and measuring it as it passes out of the sensor. The measured amount will be converted to digital data and stored on unit solid state memory with a timestamp.

A temperature sensor will report the temperature in the area of the unit. The temperature value will be converted to digital data and stored on the unit solid state memory with a timestamp.

A camera will take pictures verifying weather conditions and showing users a visual of the area around the sensor. The picture will be converted to digital data and stored on the unit solid state memory with a timestamp.

A GPS will provide location information for the unit to report location information with other real-time metrics. The GPS coordinates will be converted to digital data and stored on the unit solid state memory with a timestamp.

A barometric pressure sensor will allow extra verification if snow is present or just rain/sleet. The barometric pressure value will be converted to digital data and stored on the unit solid state memory with a timestamp.

A power converter will convert the external NC power source from a power grid to DC power for the internal components of the snow sensor unit. The connections between the components within the device will carry electrical signals consistent with electronic communication systems (bus, ribbons, transformers) as well as power between the devices within the system.

A Logic processing unit (LPU) will have a clock unit for keeping time. That clock can be updated by a command coming from the server with the time given. At every minute time interval, the LPU will record the values from each of the sensors within the snow sensor unit and send them to the solid state memory to be stored.

The LPU will then extract the snow/moisture, temperature, GPS, barometric pressure, and camera data stored in the solid state memory and encrypt the data with the stored encryption keys on the device. It will package the data as shown in FIG. 3 or 4, depending on the package interval. The LPU will use the network controller to communicate with the server to send out packaged data.

The Network controller will attempt to send out data given to it from the LPU using the configuration stored in the solid state memory.

The solid state memory will contain time-stamped recordings of the snow/moisture, temperature, GPS, barometric pressure, and camera data. It will provide read/write ability for the LPU to store and retrieve the data on the device. The solid state memory will also contain the configuration information installed at setup. The configuration information will contain the encryption keys and network addresses for sending data to servers.

### BRIEF DESCRIPTION OF THE FIGURES

FIG. 1: Snow Sensor Components consisting of Snow/moisture sensor and collector, Device Heating Unit, Temperature sensor, Camera, GPS, Barometric pressure sensor, Power converter and connections, Logic processing unit (LPU), Network controller, and Solid State Memory.

FIG. 2: Mockup of Snow Sensor Array using adapted moisture collector and adding temperature sensor, barometric pressure sensor, camera, and GPS.

FIG. 3: Sensor data package to server showing the content of the data sent from the sensor to the server at timed intervals.

FIG. 4: Sensor data package to server without picture showing the content of the data sent from the sensor to the server at an alternate time interval.

FIG. 5: Sensors to Application Servers layout showing how the sensors will be connected to collection servers and then passed to processing servers.

FIG. 6: Application Servers to End Users layout showing how processed data is delivered to content delivery servers and end users.

FIG. 7: High-level view of Weather Sensor System showing end-to-end connections of the snow sensor and components making up the system to produce the real-time metrics to users.

FIG. 8: Network time synchronization showing how the Weather Sensors will communicate time synchronization to all parts of the system.

FIG. 9: Truck positions map showing plow tracking from the snow sensor.

FIG. 10: Total Snowfall Map data collected by snow sensors of geographic space.

FIG. 11: Road Condition Map from processed data showing major roads that have been cleared by plows and displaying road safety conditions.

FIG. 12: Road Route Conditions with camera data showing road safety and hazardous conditions with pictures for users to understand conditions in area.

FIG. 13: Snow Sensor picture data from building showing sensor unit's picture for users to view area snow conditions.

FIG. 14: Snow Sensor picture data from snow plow service showing sensor unit's picture for users to view snow conditions at plows location.

FIG. 15: Unsafe conditions due to unplowed road and driver's lack of information on a better route to take indicates the need for more sensors and information that will provide people with safer and more efficient traveling experiences.

FIG. 16: Safe roads identified with data collected by plow's snow sensor and surrounding sensors on buildings, can be traveled by people who know what streets are plowed.

### DETAILED DESCRIPTION OF THE INVENTION

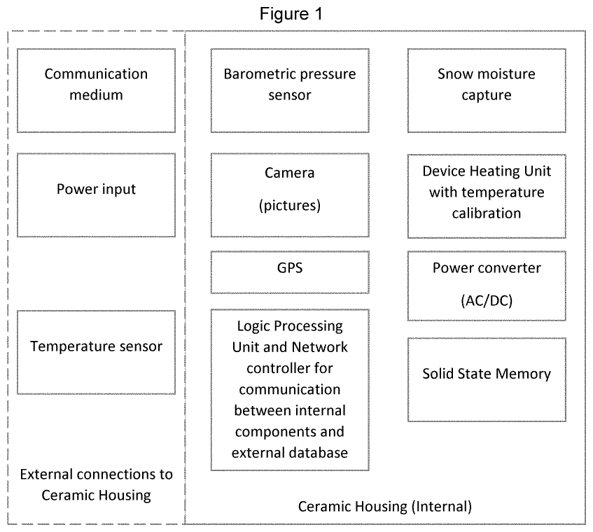

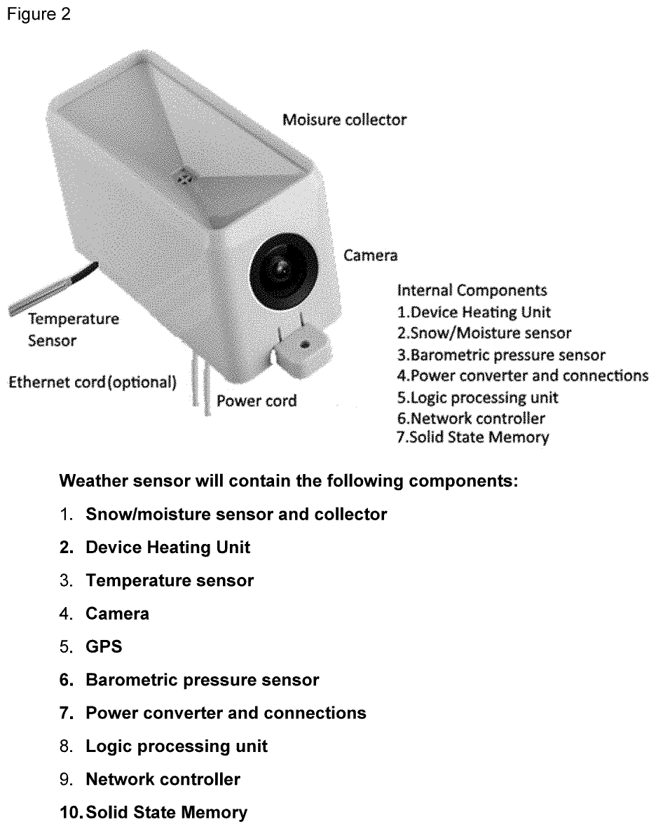

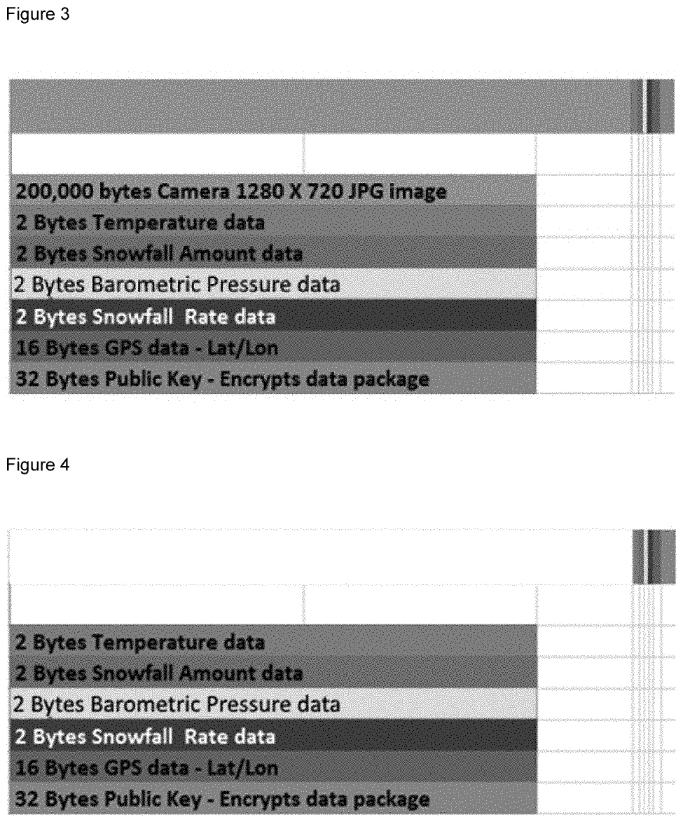

The sensor array component will be a weatherproof container with five types of sensors on it, a temperature sensor, barometric sensor, a moisture collector/sensor, a camera sensor and a GPS sensor. These five sensors will communicate with a logical processing unit (LPU) and a network enabled controller board that will encrypt and transfer the sensor data (FIG. 3-4) out to a collection server. The network enabled controller board will have both WLAN and LAN component as part of the network controller board (FIG. 1-2). The network controller component will draw power from an electrical grid's outlet or small electrical post.

The device will contain a firmware/memory alongside the LPU to store configuration information like encryption keys, decryption keys, settings for where to send the data, and the sensory information. These devices will collect store one month of data before aging it out of memory. This allows us to keep the units small with very little memory space needed.

Use of buildings and cellphone towers allows access to existing electrical and communications infrastructure for powering and transmitting data from the devices. These locations allow us to use the physical security already in place to protect our devices from theft or vandalism.

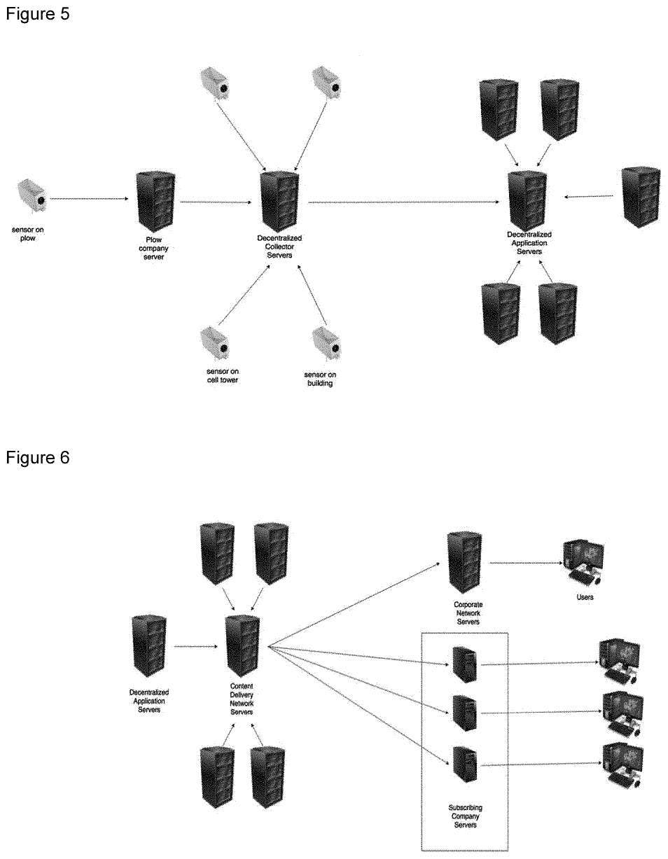

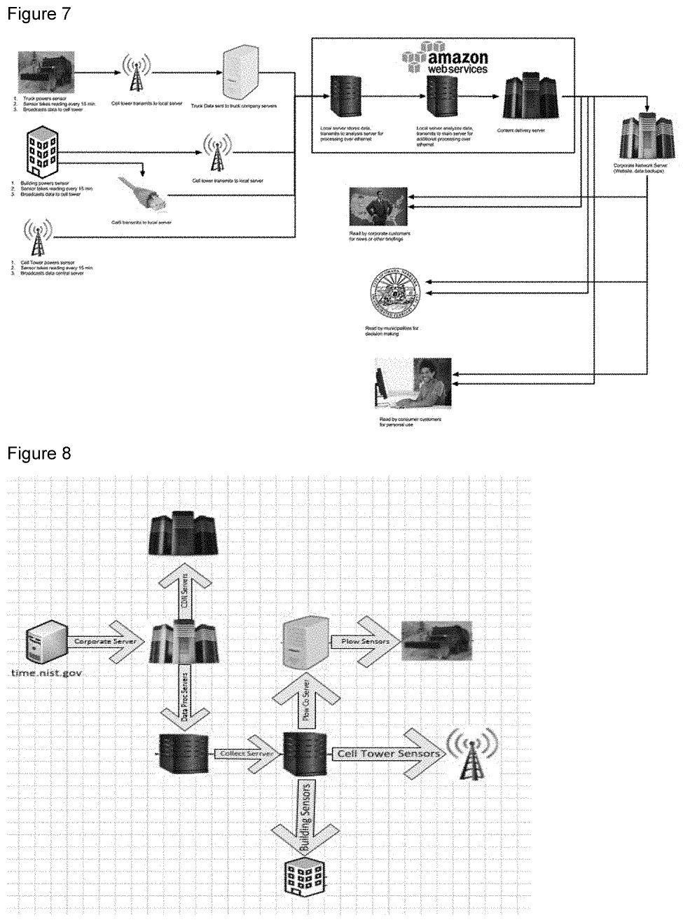

The sensors will perform as nodes in a decentralized network (FIG. 5-7). They will be thin-client layered architecture with only enough software to collect, encrypt, and transmit data/status.

This part of the system will be a centralized design within each network of the plow companies. The sensor arrays will be connected to their network and communicate with collector software on their server. With this design, we ensure that devices not properly authenticated to the collector service on the server are not able to breach the system with bad data. Also, we use the physical security protecting the plows to protect our sensors. The collector service will be the only component that can authenticate to the decentralized server network and transmit the data collected from the plows.

This design allows the IT staff to easily set up and maintain the devices and their software. There is no complex hand off to multiple servers for any reason or miscommunication by the devices to the wrong server. However, there are pitfalls to this design. First, if the providing server is not working properly, then we are not getting data from them and there is no backup system to transmit the data. Second, if the server is lost, then the data is also lost, unless they have backups.

The server components of the system will be on virtual servers to handle varying density differences of each geographical space. This will allow the number of servers used to increase or decrease according to changes in population. It will also allow for quick recovery of a failed server, since we can just spin up another instance of the server to take over responsibility. Virtualization will allow the system to achieve distributed system transparency.

The system uses decentralized servers spread throughout density varying geographic spaces. The density of the sensors is directly proportional to the human population in geographic space. These servers receive the sensor information from the sensor arrays on buildings, cellphone towers, and plow companies within each geographic space. Their responsibility is to get the data from the sensors to the logic processing servers within their geographic space. The collection of data can be performed independently of other servers and still be pushed through the system. The server can work with the data it has even if there are missing pieces from servers that are not functioning. These servers are periodically backed up to the Amazon Web Services network.

The system will use decentralized servers to handle processing of data coming from collection servers. These servers, at a lower density than the collection servers, will mirror the collection servers in the geographic space. Their responsibility is to receive information from the sensors and do the initial processing on the data before sending it on to edge and corporate servers. The servers will work with two channels of data coming in from the sensors. The first channel will handle numerical data for analytical processing. The second channel is the visual data for image processing.

The decentralization of these servers allows each geographic space to function separately without being affected by another. The analysis can be performed on its own set of data, giving a basic picture of what environmental conditions are going on in that space. The system is designed to take additional data from its nearest neighbor to create a fuller and slightly larger picture of what environmental conditions are present and could be a concern. The decentralized services in this design is that they will act as middle-tier components in the system. Although there is complexity introduced by multi-layering, simplicity is achieved as each layer performs a sole purpose.

Edge servers will act as content delivery agents for redistributing the information from the logic processing servers. These decentralized servers will distribute information to supported services (National Weather Service, Federal Aviation Commission, Nebraska Department of Roads). They contain the bulk of the storage needed for archiving the data of this system and presenting the data to the subscribers.

Since the logic processing servers and the CDN are decentralized, the CDN can still get information from many of the geographic spaces, even if some of them are down or not communicating for whatever reason. This design helps to make sure latency and delay is minimized for the users or systems trying to pull the data. This also helps with load balancing of users and making it so that users only pull data relevant to their geographic space. It also allows redundancy of data from the decentralized servers, so we don't have single point of failure and we have recovery within the system.

In the City of Omaha, data collection from 200 plows with sensor readings every minute and camera images included in every minute reading, equates to 12,000 readings an hour. Combine that with sensors on 750 buildings and 50 cell towers (800 static locations) around Omaha providing another 48,000 readings, for a total of 60,000 readings an hour, or 1,000 readings every minute for the Omaha metro area. Using GPS longitude and latitude readings from each transmission, we will need to not only map the specific reading from each sensor correctly, but then average readings to represent snowfall over a geographic area. The main complexity lies in how to average an area based on many disparate readings over time. If there is a significant difference in snowfall over an area, we will want to break up snowfall into a greater number summary zones, while if snowfall is uniform, we can use more generalized zones.

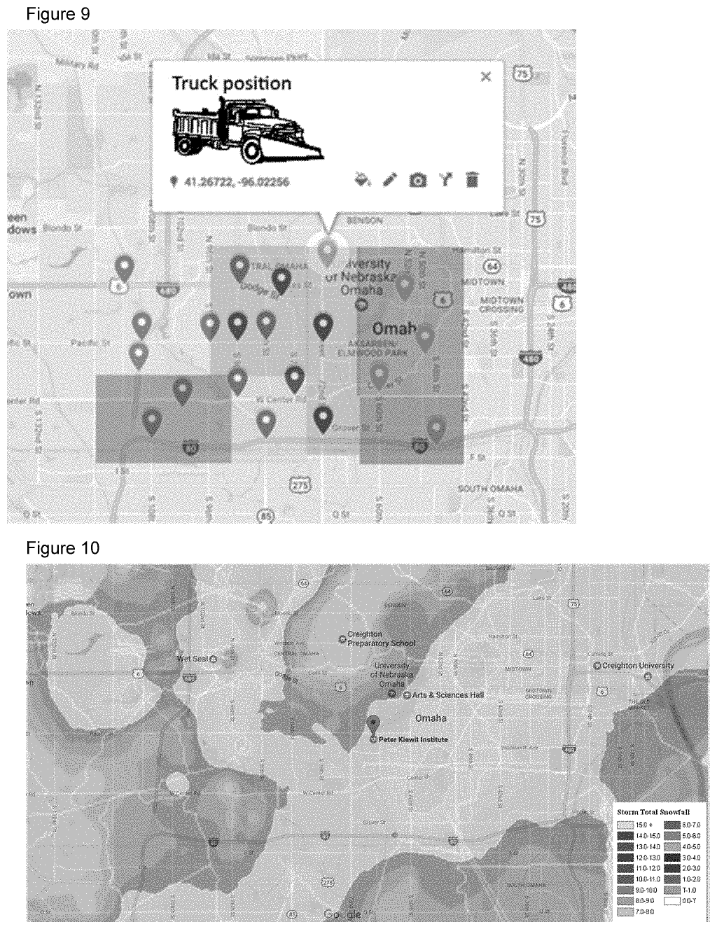

The decentralized application logic processing servers will handle data analytics for a region, pushing completed localized data to the content delivery servers. The content delivery servers will handle any overlap discrepancies and create the finalized map to be published. Using our decentralized server methodology, we believe it will not be a challenge to represent all the collected data in real-time. With sufficient computing resources, the 5-minute window between readings will be enough time to:
Map the measurement correctly based on GPS coordinates at the time.
Use zoning algorithm to average readings over a given area and decide on zone condition.
Publish truck locations, road status, and images to web (FIG. 9).
Draw the new maps for viewing on the web portal.

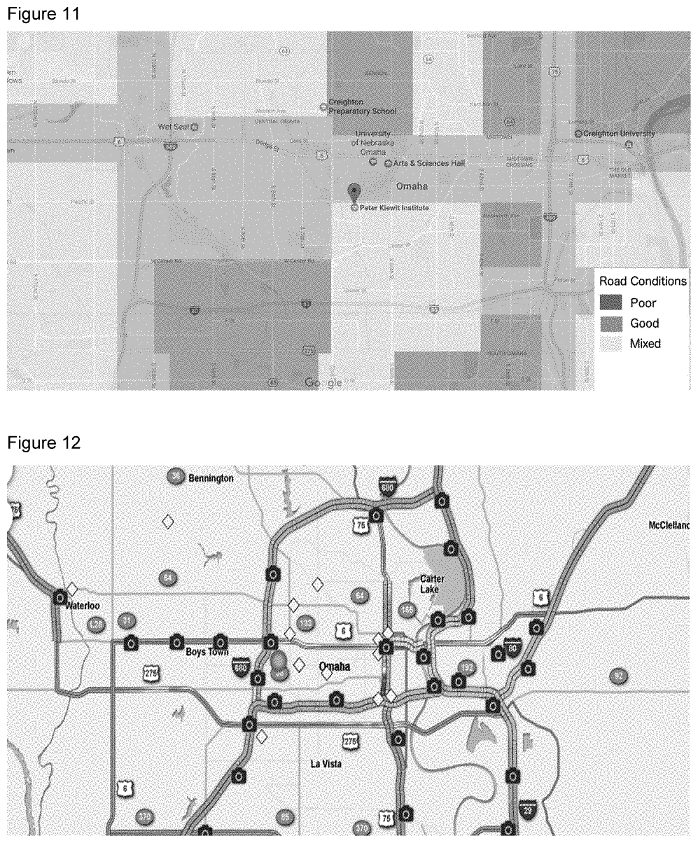

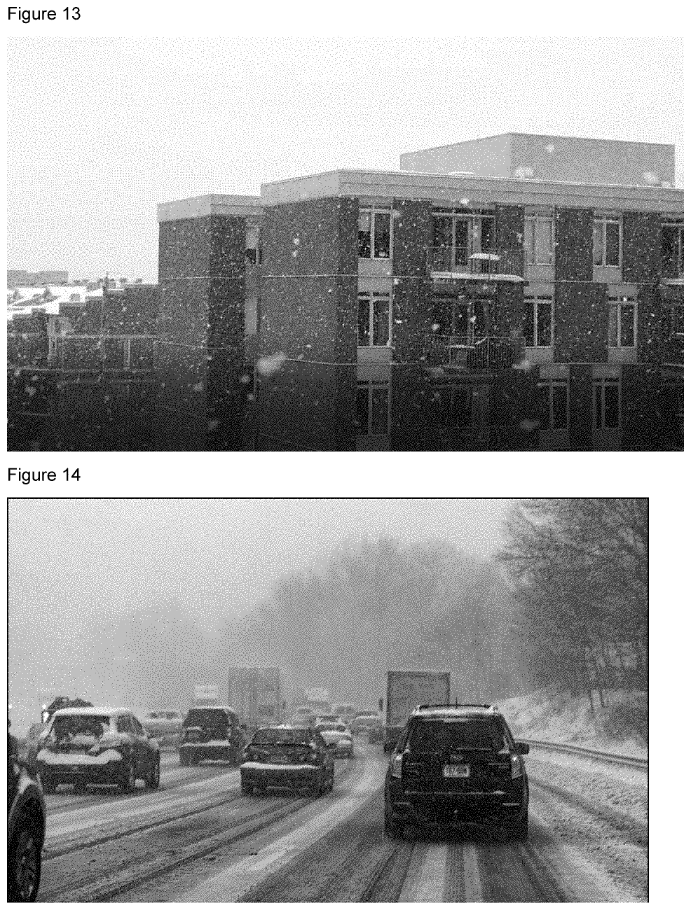

Utilizing our tiered server system, processed data will be stored at our content delivery servers for publishing via Amazon Web Services and sending directly to customers. The primary output from our system will be a snow map that illustrates actual snowfall in near real time for cities across the country. Subscribers to our service will be able to log in and view, with functionality like that of Google maps:
Actual snowfall for a geographic area.
Comparison of predicted snowfall based on actual snowfall in other regions and forecast data.
Detailed street snow conditions (FIGS. 11-12).
Images of street conditions (FIGS. 13-14).
Plow information such as
   Brine/sand dropping.
   Streets plowed.
   Plow locations.
Rural snowfall information. Due to network availability and sensor installation/maintenance rural is considered an area with additional challenges

As mentioned, we will have enough computing power to provide an all-in-one solution, simplifying the need to calculate different outputs for different customers. Whether you are an individual consumer, news agency, or municipality, all the data you need is available through the web portal. For security concerns, we may implement data-hiding features as needed. For example, only a city can access plow locations in real time.

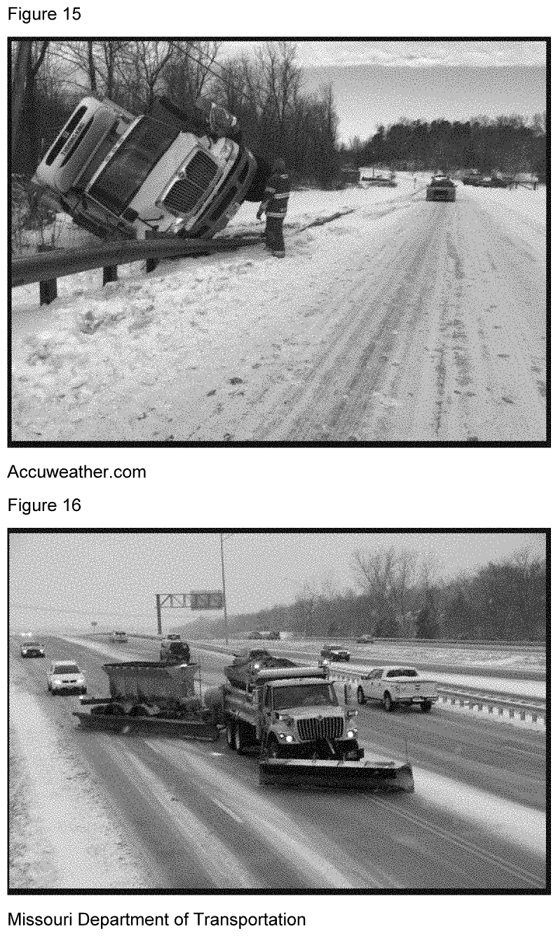

As snowfall can vary over a single metropolitan area, we will provide accurate regional data for road conditions, plowing status, and total snowfall (FIG. 10). By utilizing our sensor arrays with GPS and captured images, we can create a ‘road condition’ map that highlights progress made by plows and shows where it is safe and not safe to drive within the city (FIG. 15-16). Using our snow sensors, we can show exactly how much snow has fallen within a small geographic area using our ‘snowfall map’.

The cost of employees not going to work due to the prediction of one heavy snowstorm has been estimated at $48.8 billion nationwide. Our real-time snowfall map will allow schools, event planners and business people to decide whether to cancel or close due to weather. More importantly, drivers will be able to make informed decisions about road conditions and choose not to drive, instead of ending up in a dangerous or, at best, unknown situation.

Communications between various data collection, storage, analysis, and presentation components of the system will follow the overall blueprint and connections between the elements of the system were described in detail in previous sections. The raw data collected from the sensors includes snowfall rates, snowfall amounts, temperatures and jpeg images in 1280×720 resolution. The data package sent out from the sensors will include these data elements, along with GPS coordinates and a 32-byte AES-256 public key of the receiving server. This section will discuss the specific details for each communication channel in the system.

Static location sensors will be connected using twisted pair Cat 5e or Cat6 cables, which will be available on the buildings and cell towers where they are installed. Sensors placed in fixed locations without network cables available at the installation site may connect to wireless LANs and transmit data in the 2.4 or 5 GHZ frequency ranges which are standard for wireless routers. Where possible, plow truck sensors will connect to the existing network infrastructure that the trucks already use for two-way data transmissions with their central offices. Sensors on plow trucks owned by companies or municipalities that do not already have a communications infrastructure in place will utilize cellular data with wireless transmissions in the 700-900 or 1700-2100 MHZ frequency ranges for 4G LTE cellular data, depending on carrier.

The physical layer components described above for the weather sensors do not represent the entire communication path the data must travel. The media described above represent only the first, and shortest leg of the full path the data must travel to reach the other components of the system. For static location sensors, whether wired or wireless, data will flow through the local area network, to the router acting as the internet gateway for the LAN to be sent out to the internet. Once data has reached the internet gateway, the best route is calculated, and the data is sent out along telephone lines or coax cables from the sending location until it reaches a much larger T1 or T3 line, which simply specifies the maximum data rate, but not the media that the data travels along. However, these lines are generally fiber optic or coaxial cables. It will travel over these larger lines until it gets to its destination where it will follow the reverse process, travelling over telephone lines or coax at the receiving location to the internet gateway of the receiving location. Once inside the recipient's LAN, it will travel over twisted pair cables or over the wireless LAN 2.4or 5GHZ frequencies. Data being sent between the plow company, collection, data processing, content delivery and corporate servers in the system will follow a similar path from out from the sending LAN and into the recipient LAN.

There are no specific elements related to the data link layer that are distinctly different from other distributed systems. There are elements in the network and transport layers however that warrant explanation. Communication in the network layer will be done using the IP protocol. The recipient IP address will be part of the sensor firmware that can be remotely updated with changes to the recipient IP as needed. For servers sending data, the recipient IP address will be identified in the application running on the server. The element in the transport layer that has a significant impact on the system is the use of the TCP protocol. This was chosen because data completeness is more critical than timeliness and the data sizes are so small that additional overhead should not significantly hamper performance.

The application layer for communication from the sensors will contain the elements in the data package described above. Readings will be taken approximately every minute (five minutes for readings with images), and based on estimated data package sizes, each sensor will need to transmit about 2.5MB of combined digital image and text data per hour. Encryption and decryption of both the data packages and communications will be performed in the application layer and specifics are discussed in the security section below.

Utilizing TCP and the connection management features it provides at the transport layer will help ensure that when network connectivity is available, messages that are transmitted by the sensors are accurately and completely received. However, additional steps must be taken to ensure sensors are functioning correctly, capturing valid data, and accurately and completely transmitting that data.

Record management within the static location sensors and plow truck sensor application software as well as on the plow company servers will be utilized to monitor which records have been transmitted and acknowledged by the recipient servers. This will help verify that all data has in fact been transmitted and received. Data transmission will occur every minute and any record that does not have an acknowledgement that it was successfully received will be retransmitted the next time data is sent.

The jpeg image, along with the temperature, barometric pressure, snowfall amount and snowfall rate text data have been combined into a single data package because of the extreme disparity between the sizes of the data. The binary jpeg data will account for more than 99.9% of the actual data package with the text data accounting for less than a fraction of a percent. If an acknowledgement is not received, the image data will need to be retransmitted. Sending the text sensor readings again adds almost no additional size to the data package so it is sent again as well. This retransmission will happen for the packaged data that doesn't have the jpeg image in it.

Additional failure monitoring and notification will also be required. Network connectivity failures of static location sensors will need to be identified and communicated by the collection servers. To accomplish this, each collection server will maintain a list of nodes in its domain and will send an alert if it has not received data from any node for 5minutes (5cycles). Failures of the thermometer, barometric pressure sensor, snowfall sensor, GPS, and cameras will be identified on the data processing servers after the data from the collection servers are decrypted. Data that cannot be decrypted, split into valid jpg images, and text components will raise an alert. Each individual component will also be reviewed for accuracy, ensuring valid images and accurate sensor readings are being transmitted. Examples of alerts would include but not be limited to things such as precipitation readings with nothing indicated in the images or high temperature readings when snow is falling. All warnings from collection, data processing and content delivery servers will be sent to the corporate server to be reviewed and addressed by IT staff.

Data synchronization will be critical to the system. Ensuring images and data received from sensors are in the correct sequential order is not sufficient. All components within the system must be using the same clock to maintain data integrity within the system and to ensure processed data and images that consumers access have the correct time. Synchronization will be accomplished using NTP, the network time protocol (FIG. 8). The corporate server will serve as the master system clock polling an NTP server to establish the correct time. Data processing servers and content delivery servers will poll the corporate server to determine the correct time. Regional collection servers will poll their designated data processing server to determine the correct time. Static location nodes and plow company servers will poll their designated regional collection server to set the correct time. Mobile plow truck sensors will poll the plow company server to determine the correct time. This layered approach should minimize the latency as only the corporate server is calling the NTP servers. All other servers are accessing the closest link in the network to determine the correct time.

Multiple layers of security will be needed in the system. The goal is not to guard against all threats, as that is unrealistic, but to provide a reasonable level of protection against the most likely and damaging threats. Physical security of the sensors themselves will be required and the location of the sensors should provide the security required. Static sensors will be installed on cell towers, on buildings, and in locations where access is inherently restricted. Also, as mentioned in the architecture section, these locations are established cell tower sites and buildings that already have some level of on-site security presence that will increase sensors security as well. Mobile sensors will be on plow trucks which are significant assets and will already be secured by the owning organization.

Data security will also be required to protect the temperature, snowfall sensor and image data being transmitted. The locations will provide some security here as well since physically accessing the wires the data is traveling on should be relatively difficult. Wireless transmissions have a greater risk of being intercepted because they will travel some distance from the sensor. In locations where wireless transmissions are required, in addition to encrypting the sensor data itself, the transmission range will be minimized, and those transmissions will also be encrypted using WPA2/AES and long pass phrases. This will make it very difficult to decrypt messages even if they are intercepted.

In addition to physical security measures, encryption will also be utilized to protect the data in transit. A logic processing unit will be included in both static and mobile sensor hardware and will handle encryption and decryption operations. With one-minute intervals between sending data along with the small data sizes being transmitted, the sensors can easily be designed with sufficient processing power, so performance is not impacted by encryption. The reading and image data being sent out from the sensors will be encrypted using the public key of the receiving server and this key will be stored in the sensor firmware. Data will remain encrypted until it reaches data processing application servers that will decrypt, verify and process it. Communications between data processing, content delivery and corporate servers will also be encrypted utilizing transport layer security (TLS) protection.

Data for managing the system will need to be sent to sensors and that data will also need to be encrypted. Sensors will need to receive critical information updates, including recipient server IP address changes and time updates. The logic processing unit will be used here as well. A private key will be included in the sensor firmware and will be used to decrypt messages for these updates that are sent to the sensors. The use of keys will ensure these critical updates, which will be encrypted by the servers using the associated public key for the receiving sensor, are properly authenticated before any updates are performed.

1. A real-time snow monitoring system, comprising:
a sensor array, comprising:
at least one snow sensor on a mobile or stationary mounting distributed in one or more areas, wherein at least one of said snow sensor is configured to measure an amount of snow accumulated in one or more areas;
at least one temperature sensor on a mobile or stationary mounting associated with one or more areas, wherein at least one of said temperature sensor is configured to monitor ambient temperatures;
at least one camera on a mobile or stationary mounting associated with one or more areas, wherein at least one of said camera is configured to provide weather conditions of one or more areas; and
at least one barometric pressure sensor on a mobile or stationary mounting associated with one or more areas, wherein at least one of said barometric pressure sensor is configured to detect a presence of snow in one or more areas; and
a processor communicatively coupled to at least one snow sensor, at least one of said temperature sensor, at least one of said camera, and at least one of said barometric pressure sensor, wherein said processor is configured to:
receive data from at least one of said snow sensor, at least one of said temperature sensor, at least one of said camera, and at least one of said barometric pressure sensor via a network;
extract the data from at least one of said snow sensor, at least one of said temperature sensor, at least one of said camera, and at least one of said barometric pressure sensor.

2. The snow sensor of claim 1, further comprising a multiple of said snow sensors thereafter generates road condition maps based on the data.

3. The generated road condition maps of claim 2, can be subsequently transmitted to a user.
